(19) United States
(12) Patent Application Publication
(10) Pub. No.: US 2025/0239027 A1
(43) Pub. Date: Jul. 24, 2025

(54) EXTENDED REALITY ENCODING

(71) Applicant: V-NOVA INTERNATIONAL LIMITED, London (GB)

(72) Inventor: Guido MEARDI, London (GB)

(21) Appl. No.: 18/855,524

(22) PCT Filed: Apr. 14, 2023
(86) PCT No.: PCT/GB2023/051010

§ 371 Date: Oct. 9, 2024

(30) Foreign Application Priority Data
Apr. 14, 2022 (GB) 2205618.8

(51) Int. Cl. G06T 19/00; G06F 3/14; G06T 9/00

(52) U.S. Cl. CPC G06T 19/006; G06F 3/14; G06T 9/00; G06T 2210/22; G06T 2219/2016

(57) ABSTRACT

A system for displaying an image frame sequence, the system comprising an image source and a display device, wherein the image source is configured to: generate an image (3); obtain a predicted display window location (2a); and transmit the generated image (3) and the predicted display window location (2a) to the display device; and wherein the display device is configured to: receive the generated image (3) and the predicted display window location (2a) from the image source; and adjust the generated image to obtain a first adjusted image (1 a) corresponding to the predicted display window location (2a).

### FIELD OF THE INVENTION

The following disclosure relates to systems in which images are generated and displayed on a display device, such as in VR or XR applications. The images may for example virtually represent a 3D space. The display device may for example be a user headset. The images are commonly generated remotely from the display device, and there are typically limitations on the communication speed and capacity between the image source and the display device. For example, the image source and the display device may be connected via a network, and the image source may for example be located on a server or in a cloud.

### BACKGROUND

The graphics of current generation game consoles require hundreds of Watt of power, cooling systems, discrete graphics cards and so on, all of which can lead to a device that is too big and heavy to be used as a headset.

In order to provide a practical headset supporting similar graphics (for example in a VR, XR or metaverse application) it can be necessary to render the graphics on a separate device (e.g. on a local device or a remote device such as a cloud system) and then transmit rendered images (or another form of visual data such as point clouds) to a display device.

Due to the limitations on speed and capacity of communication between devices, as well as the processing speed and processing resources required for image generation, it is desirable to minimise factors such as the frame rate and the quantity of transmitted data as far as possible without compromising user experience.

For example, in a system comprising a cloud server and a VR headset, it is unlikely that the communication speed is higher than 50 Mbps. This is not high enough to support stereoscopic 4K at high frame rates (e.g. 72 fps). Therefore, it can be necessary to either limit the quality of the VR display, or to implement compression techniques, and preferably lossless compression techniques so that the final display does not have compression artefacts.

Additionally, due to the time required for generating an image and communicating the image to the display device, there can be a discrepancy between the display that is required at the time of generation of an image and the display that is required at the time of displaying the image at the display device. Rendering, encoding, transmission and decoding all take time, and so the time of displaying the image may be at least 30 ms after the time of generation of the image. For example, when the display device is a user headset, the user may move their head either deliberately or unconsciously such that the user is facing in a different direction at the time an image is generated and at the time the image is displayed. This discrepancy can make the user feel ill and is desirably minimised.

One known technique for handling limited frame rates, and delays between image generation and image display, is known as warping or time warping.

Pre-processors used in comparative warping methods are configured to pre-process (e.g. render, encode and so forth) a field of view that encompasses the field of view of the user at the time of pre-processing (e.g. a time at/just before the start of rendering) and also a (predicted) field of view at a (predicted) time of display of the pre-processed frame. For example, instead of just transmitting the video of a user's actual field of view at time T=0 ms (i.e. when the rendering begins), the user's head position is instead forecasted as XYZ(T=30 ms) based on their head motion, and a slightly bigger window centered on XYZ(T=30 ms) is rendered and transmitted starting at time T=0 ms. Then, when the bigger window is received at the user's headset, and based on the user's latest head movements, the transmitted window is adjusted based on the user's actual field of view at time T=30 ms, providing an overall impression of zero delay. Thus, comparative warping methods generally account for the predicted or potential change in field of view between the pre process time and the display time of the frame.

Described embodiments account for a change in field of view between the pre-processing time and multiple (subsequent) frames after the pre-processing time of the frame. In other words, described embodiments generate an image that encompass a range of field of views that are large enough to take into account predicted head movements that might be made over the course of the next (few) frames that follow the pre-processing time for a given frame.

Therefore generally speaking, the range of field of views accounted for in the image generated by pre-processing in the described embodiments is a larger range of fields of view than the range of fields of view generated by the comparative warping methods. Therefore, the image generated by pre-processing in the described embodiments is, generally speaking, (spatially) a larger image than the image generated by the comparative warping methods. For completeness, generally speaking, the range of field of views accounted for by the image generated in the pre-processing of the described embodiments is therefore a larger range of fields of view than the field of view accounted for by an image generated by comparative non warping methods.

### SUMMARY OF THE INVENTION

According to a first aspect, the present disclosure provides a system for displaying an image frame sequence, the system comprising an image source and a display device, wherein the image source is configured to: generate an image; obtain a predicted display window location; and transmit the generated image and the predicted display window location to the display device; and wherein the display device is configured to: receive the generated image and the predicted display window location from the image source; and adjust the generated image to obtain a first adjusted image corresponding to the predicted display window location.

The image frame sequence is a series of frames of image data. The image data may be suitable for displaying by a VR display device.

The display device may, for example, be a VR viewing device such an Oculus Quest or HTC Vive Cosmos Elite.

By generating an image which is larger than a predicted display window location, and including an indication of the predicted display window location with the information transmitted to the display device, boundaries of the image can be determined independently from the predicted display window location, and can be static for multiple frames. Making the image boundaries static can improve compressibility of the image for transmission.

Optionally, the generated image has a field of view which is an oversized field of view.

Optionally, the image source is configured to generate the image based on the predicted display window location. In other words, the image is generated to include at least a field of view encompassing the predicted display window location.

Optionally, the image source is configured to generate the image based on at least two predicted display window locations, wherein the predicted display window locations correspond to different frames of the image frame sequence. In other words, the image is generated to include a field of view encompassing at least the predicted display window location at the time of a first frame and the predicted display window location at the time of a second frame.

Optionally, the display device is further configured to: obtain a final display window location; and adjust the first adjusted image to obtain a second adjusted image corresponding to the final display window location. Optionally, the display device is further configured to: display the second adjusted image. In other words, warping can be performed in addition to the process of the first aspect

The final display window location may be a field of view of a user in a 3D rendered space, at a time of displaying the image.

Adjusting the first adjusted image may comprise cropping, translating or rotating the first adjusted image.

The predicted display window location may be a prediction of a field of view of a user in a 3D rendered space at a time of displaying the image frame, wherein the prediction is made at a time of rendering the image frame.

Adjusting the generated image may comprise cropping, translating or rotating the generated image.

Optionally, the predicted display window location is indicated using a coordinate value.

Optionally, the display device is further configured to: receive a second predicted display window location from the image source; and adjust the generated image to obtain a third adjusted image corresponding to the second predicted display window location. In other words, the display device is configured to use a single generated image to obtain adjusted images corresponding to multiple predicted display window locations.

Optionally, the display device is further configured to: calculate a second predicted display window location; and adjust the generated image to obtain a third adjusted image corresponding to the second predicted display window location. In other words, the display device may use a single generated image and a single predicted display window location to obtain adjusted images corresponding to display window locations. For example, the display device may use a motion vector associated with the first predicted display window location to calculate the second display window location, without requiring further communication from the image source.

Optionally, the display device is configured to store the generated image of a previous frame and the image source is configured to transmit a difference between the generated image of a current frame and the generated image of the previous frame. When the boundary of the generated image is static for multiple frames, the difference between images of different frames is reduced and the image can be more efficiently compressed by transmitting a difference from a previous image.

Optionally, the image source comprises an encoder and the display device comprises a decoder, the image source is configured to: encode the generated image and the predicted display window location as an encoded frame; and transmit the encoded frame to the display device, and the display device is configured to: receive and decode the encoded frame to obtain the generated image and the predicted display window location.

Optionally, the image encoder is an LCEVC encoder and the image decoder is an LCEVC decoder.

LCEVC compression performance can be particularly efficient for scenes that include static components and high-motion components. However, in the case of small or random motions, LCEVC efficiency can be lower. As mentioned above, according to the invention, boundaries of the transmitted image can be determined independently from the predicted display window location, and can be static for multiple frames, meaning that LCEVC can provide efficient compression in combination with the method of the first aspect.

Optionally, the system further comprises a network, wherein the image source is configured to stream the image frame sequence to the display device over the network.

According to a second aspect, the present disclosure provides a transmission method for a system for displaying an image frame sequence, wherein the method comprises: obtaining a generated image from an image source; obtaining a predicted display window location; and transmitting the generated image and the predicted display window location to the display device.

According to a third aspect, the present disclosure provides an encoding method for a system for displaying an image frame sequence, wherein the method comprises: obtaining a generated image from an image source; obtaining a predicted display window location; and encoding the generated image and the predicted display window location as an encoded frame.

According to a fourth aspect, the present disclosure provides a receiving method for a system for displaying an image frame sequence, wherein the method comprises: receiving a generated image and the predicted display window location from an image source; and adjusting the generated image to obtain a first adjusted image corresponding to the predicted display window location.

According to a fifth aspect, the present disclosure provides a decoding method for a system for displaying an image frame sequence, wherein the method comprises: decoding an encoded frame to obtain a generated image and a predicted display window location; adjusting the generated image to obtain a first adjusted image corresponding to the predicted display window location; and outputting the first adjusted image for use by a display device.

According to a sixth aspect, we describe a method of generating data suitable for constructing a series of frames of image data. The constructing may be by a viewing device, in particular a VR viewing device such an Oculus Quest or HTC Vive Cosmos Elite. The image data may be suitable for displaying by a VR display device. The method may comprise determining an oversized field of view. The oversized field of view may comprise and/or encompass and/or be larger than a first field of view. The first field of view may correspond to an expected field of view. The expected field of view may be a predicted/expected field of view that will be (and/or be expected to be) displayed on the VR display device at a display (and or generation) time of a first frame (of the series of frames).

The oversized field of view may comprise and/or encompass and/or be larger than a second field of view. The second field of view may correspond to an second expected field of view. The second expected field of view may be a predicted/expected field of view that will be (and/or be expected to be) displayed on the VR display device at a display (and or generation) time of a second frame (of the series of frames).

The method may comprise generating an oversized image having said determined oversized field of view. In other words, the oversized field of view comprises a field of view that is large enough to encompass: a first field of view corresponding to a generation and/or display time of the first frame of image data; a second field of view corresponding to a generation and/or display time of a second, later frame of image data. Generating the oversized image may comprise processing input data.

The input data may comprise multiple images to render, data indicative of a viewer's field of view, viewer data, volumetric data, technical information indicating a resolution of the VR display device, information fed into a renderer. Generating the oversized image may implicitly comprise the previously described determining the oversized field of view step. In general, the oversized image is to be processed by a display module of a VR display device in order to generate a VR scene for the viewer, wherein the viewer has a field of view that may be dependent at least upon the viewer's head and eye position or movements.

According to a seventh aspect, we describe a related method, preferably performed by the VR display device, of generating a sequence of frames for displaying on the VR display device. The method may further comprise displaying the generating a sequence of frames for displaying on the VR display device. The method of generating a sequence of frames for displaying on the VR display device may comprise obtaining an oversized image (such as the oversized image described above) having an oversized field of view, wherein the oversized field of view may comprise: a first field of view corresponding to a (known or predicted) display time of a first frame; and a second field of view corresponding to a (known or predicted) display time of a second, later frame. The method may comprise obtaining first positional data for the first frame, wherein the positional data is suitable for combining with the oversized image to generate the first frame. The method may comprise combining the oversized image with the first positional data, to generate the first frame (i.e. for displaying on the VR display device) at a first display time. The method may comprise obtaining positional data for the second frame, wherein the positional data suitable for combining with a rendition of the oversized image to generate the second frame. The method may comprise combining the rendition of the oversized image with the second positional data, to generate the second frame (i.e. for displaying on the VR display device) at a second display time. The second display time may be after the first display time. Thus, generally speaking, the method may comprise applying a stabilization method to (a rendition of) the oversized image, to generate a first frame. At a later time, the method may comprise applying a stabilization method to (a rendition of) the oversized image, to generate a second frame. The method may further comprise warping the first frame to produce a warped first frame. The warping may comprise adjusting the first frame based on data received from sensor at (or momentarily before) an intended display time of the first frame.

The method may comprise the VR display device obtaining positioning data, the positioning data suitable for combining (at the VR display device) with the oversized image to create a reduced image. The reduced image may be suitable for providing the field of view at the viewing/display time. The method may comprise the VR display device obtaining, at a later time, subsequent positional data where in the subsequent positional data is suitable for combination with a rendition of the generated oversized image in order to create a further reduced image, wherein the reduced image represents (or is suitable for providing) a field of view of the viewer at a later time (i.e. a time associated with the display and/or generation of the further image). The positional data may be associated with a frame or frame time or viewing time and the subsequent positional data may be associated with a subsequent frame or subsequent frame time or subsequent viewing time.

According to an eighth aspect, we describe a related, further, method, preferably performed by the VR display device. The method may comprise adjusting the oversized image by using a received and/or generated first positional data to select a field of view encompassed within the oversized image at a first time. The first time may be a time at which the oversized image was obtained (e.g. by the VR display device) and/or a time at which the selected field of view will be displayed. The method may comprise, at a later time, updating a rendition of the oversized image (i.e. an oversized image that was originally generated in conjunction with a previous frame, such as the first frame), by using a second received and/or generated positional data to select a field of view encompassed within the rendition of the oversized image, the selected field of view may correspond to the field of view of a viewer at the time of updating and/or a predicted time of display of the updated image. The rendition of the oversized image may be a result of enhancement data (e.g. such as residuals, in particular, residuals obtained from an LCEVC stream) being applied to the oversized image.

The method may comprise generating (e.g. by the VR viewing device) the rendition of the oversized image by enhancing the oversized image using enhancement data. The enhancement data may be derived from an LCEVC enhancement layer.

By field of view, we generally mean a view that is viewable by a viewer of the VR viewing device, for example, at a given time. A field of view may depend on multiple factors, such as an eye position and/or movement of the viewer, such as a head position and/or movement of the viewer, a resolution of the VR display device, a size of the VR display device. Field of view may also be refer to as a scene, because this is what a viewer of a VR display device views at a given time.

In other words, the oversized field of view may comprise a field of view that is larger than: a field of view at a time of said generation of the oversized image; and/or a predicted and/or expected field of view at an intended display time of a first frame of the series of frames; and a predicted and/or expected field of view corresponding to a time at which a future (e.g. second, third, further, and so forth) frame is to be displayed (by the VR display device). An expected field of view may be considered as a field of view that encompasses the widest predicted range of field of views. In other words, the expected field of view may encompass a field of view that corresponds to an extreme (but realistic) head movement of the viewer of the VR display device.

Positional data may be data that can be combined with the oversized image that results in an image that accounts for movements of the viewers head and or eyes, relative to a previous time (such as a time that the oversized image was generated).

The VR display device may be referred to as VR viewing device. References to VR can also be a reference to AR, or more generally, XR.

In comparative methods, for example, a warping method, an image may be generated (e.g. rendered) that is larger than the final display image. However, the generated image is only created to be large enough to capture a (potential) change in field of view between the generation time of the image and the display time of that generated (and subsequently warped) image. In contrast, embodiments of the described methods generate create an ‘oversized’ image that is large enough to capture any potential changes in field of view between the generation time of the (first) image and a generation or display time of a second, third, fourth, fifth image. Thus, in general, the oversized image of described methods is larger than the image generated in the comparative warping methods. Generating such a large image as part of a comparative warping method would be counter intuitive because comparative warping methods send an (entire) updated frame at regular intervals (and before the following frame needs to be displayed). Therefore, a skilled person would consider that modifying a comparative warping methods to send such an ‘oversized’ image would be an inefficient use of bandwidth between the a pre-processing device (e.g. a renderer) and the VR display device.

In described embodiments, the oversized image may be encoded using a hierarchical codec, in particular using LCEVC. By sending a single oversized image, that comprises the field of view for multiple frames, LCEVC temporal methods can be utilised. This is because LCEVC temporal data (i.e. ‘deltas of residuals’) can be utilised, rather than non-temporal signalling (e.g. actual residual values) because the oversized image can be adjusted (and/or enhanced) by the LCEVC temporal data due to the oversize image comprising the field of view for multiple frames. In other words, the oversized image can advantageously be (re)used for multiple frames (i.e. frames displayed on the VR display device) by combining the oversized image with positional data (e.g. such as a viewer's field of view within the oversized image at a given time/frame) for each frame. Thus, generally speaking, using a single oversized image and multiple sets of positional data. This is in contrast to comparative warping methods which send over (i.e. from the ‘renderer to the VR display device) a ‘fresh’ frame for each frame that is being displayed by the VR display device.

According to a ninth aspect, we describe a related method, in particular a method of pre-processing data (e.g. volumetric data, positional data, and so forth) for encoding. The pre-processing may generally comprise processing data to generate a rendition of image data, for example, a frame of image data, multiple planes of image data, encoded renditions of image data. The method may comprise generating an image (for example, the aforementioned oversized image) for encoding, wherein a rendition of the image is suitable for use by a VR display device for creating a VR display for a viewer of the VR display device. The rendition may be a decoded version of an encoded rendition of the image. The image may comprise a field of view that is larger than and/or encompassing a field of view of the viewer at a (e.g. predicted and/or reasonable and/or expected) generation time of the image. The image may comprise a field of view that is larger than and/or encompassing a (e.g. predicted and/or reasonable and/or expected) field of view of the viewer at a display time of the generated image. The image may comprise a field of view that is larger than and/or encompassing a (e.g. predicted and/or reasonable and/or expected) field of view of the viewer at a display time of a further image. The generated image and the further image may form a sequence of images suitable for viewing by a viewer, the further image being displayed later in the sequence (i.e. at a later time).

The method of pre-processing may comprise encoding the image, in particular using LCEVC encoding methods. The method of pre-processing may comprise sending the encoded image to a VR display device, via a wired or wireless connection.

The method of pre-processing may comprise capturing positional data, via a sensor, for obtaining a field of view of a user. Positional data may be indicative of the viewer's head and/or eye position and/or gaze. The method of pre-processing may comprise generating the image by processing said positional data associated with a time of said generation.

According to a tenth aspect, the present disclosure provides a device configured to perform the method of any of the second to ninth aspects. The device may comprise a processor and a memory storing instructions which, when executed by the processor, cause the processor to perform the method. Alternatively, the device may comprise a circuit in which all or part of the method is hard-coded.

### BRIEF DESCRIPTION OF THE DRAWINGS

FIG. 1 schematically illustrates an image frame sequence according to the invention;

FIG. 2 schematically illustrates an image frame sequence according to a known warping technique;

FIG. 3 schematically illustrates a system for displaying a sequence of image frames;

FIGS. 4A and 4B schematically illustrate features LCEVC encoding and decoding which are relevant to the invention;

FIG. 5 is a schematic example of hierarchical decoding;

FIG. 6 is a schematic example of a residual map;

FIG. 7 is a flow chart schematically illustrating a method performed by an image source device;

FIG. 8 is a flow chart schematically illustrating a method performed by a display device;

FIG. 9 is a flow chart schematically illustrating a further method performed by a display device.

### DETAILED DESCRIPTION

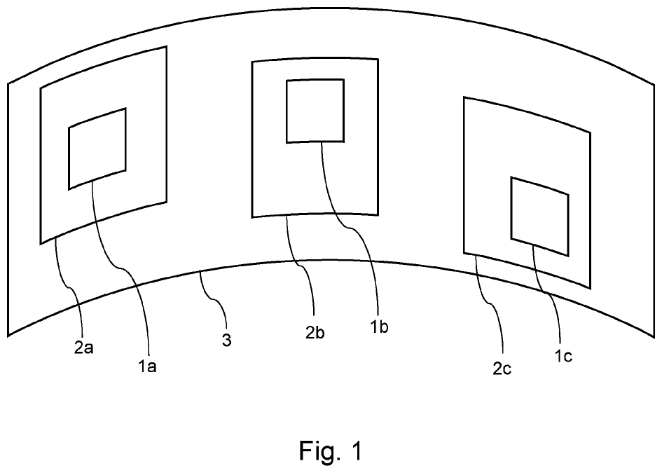

FIG. 1 schematically illustrates an image frame sequence according to the invention.

As shown in FIG. 1, a sequence of displayed images 1a, 1b, 1c displayed by a display device correspond to different portions of an overall image. The overall image may be a projection of a large 2D or 3D area, only part of which can be displayed by the display device at any given time. This is particularly applicable to VR, XR or AR displays, in which the user has a variable position and viewing direction within a virtual 3D space. The viewing direction may be linked to a position in real space—for example, an orientation of a headset. Additionally or alternatively, the viewing direction may change in dependence on virtual events in the virtual space, or user inputs such as controller inputs.

Each of the displayed images 1a, 1b, 1c is a portion of the area of a warpable image 2a, 2b, 2c which is suitable for warping before the image is displayed, based on the most up to date viewing direction of the user.

Each of the warpable images 2a, 2b, 2c is itself a portion of a static image area 3. In other words, the same static image area 3 applies to multiple frames—each frame of an image frame sequence. The static image area 3 may also change, for example when the user changes their position in a virtual environment, or when a viewing direction of the user changes by more than a threshold.

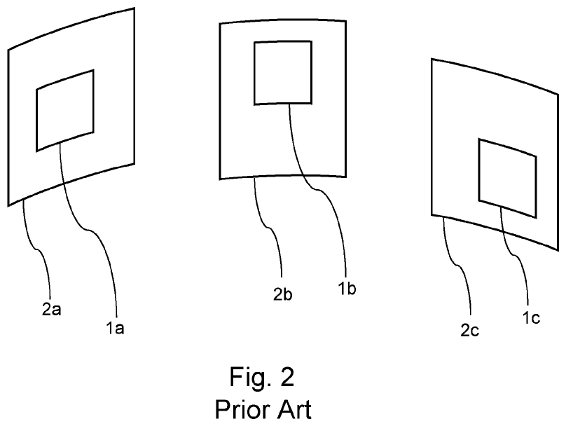

Conventionally, the warpable image 2a, 2b, 2c would be transmitted to the display device for each frame, as shown in FIG. 2. On the other hand, according to the invention as shown in FIG. 1, the entire static image area 3 is provided to the display device for each frame.

Here “provided” may mean that the static image area is freshly transmitted from an image source to the display device for each frame. However, preferably, the display device updates a stored version of the static image area 3 based on data received from the image source for each frame. By updating a stored version of the static image area, the amount of data transmitted from the image source to the display device per frame can be reduced.

For example, the static image area 3 may be encoded prior to transmission from the image source to the display device using an encoding technique which performs compression based on differences between a current frame and a previous frame. Among such techniques, LCEVC is particularly efficient for compressing the static image area 3.

The provision of a static image area 3 can alternatively be described as performing a sort of inverted stabilization of an extended field of view that is transmitted to the display device.

For example, instead of assuming that a center of the field of view (at the display time, e.g. XYZ(T=30)) is always at the center of the transmitted video, the transmitted video is stabilized as much as possible, and coordinates XYZ of a forecasted head position are additionally transmitted with respect to the transmitted video. If the user is subtly moving their head, they will receive a stable video, with a moving XYZ reference. This may then be further corrected last-minute by the warping process, as described above.

A difference between this “inverted stabilization” and conventional stabilization is that, in conventional stabilization, moving video frames are cropped leaving smaller frames in a stable window. On the other hand, this inverted stabilization method benefits from the fact that the rendering device has the entire scene at its disposal. A larger window for the image 3 is stably defined while still being able to display the original motion between frames 1a, 2a, 3a. In other words, the advantages of stabilization can be gained by expanding the extended field of view used for warping to a doubly-extended-field-of-view video.

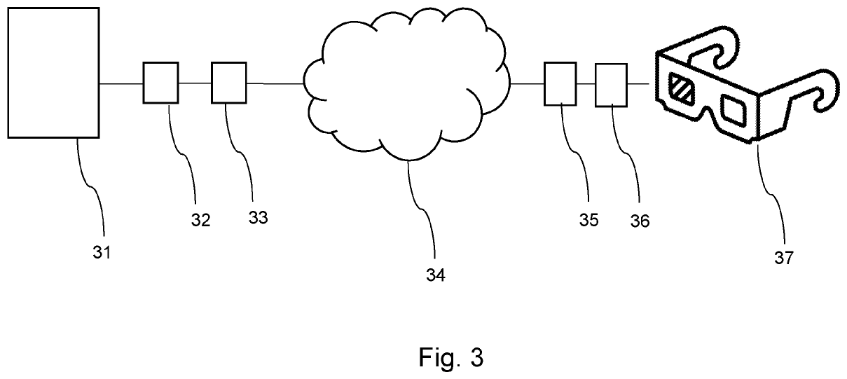

FIG. 3 schematically illustrates a system for displaying an image frame sequence.

Referring to FIG. 3, the system comprises an image generator 31, an encoder 32, a transmitter 33, a network 34, a receiver 35, a decoder 36 and a display device 37.

The image generator 31 may for example comprise a rendering engine for initially rendering a virtual environment such as a game or a virtual meeting room. The image generator 31 is configured to generate a sequence of images 3 to be displayed. The images may be based on a state of the virtual environment, a position of a user, or a viewing direction of the user. Here, the position and viewing direction may be physical properties of the user in the real-world, or position and viewing direction may also be purely virtual, for example being controlled using a handheld controller. The image generator 31 may for example obtain information from the display device 37 indicating the position, viewing direction or motion of the user. In other cases, the generated image may be independent of user position and viewing direction. This type of image generation typically requires significant computer resources, and may be implemented in a cloud service, or on a local but powerful computer. Here “rendering” refers at least to an initial stage of rendering to generate an image. Further rendering may occur at the display device 37 based on the generated image to produce a final image which is displayed.

The encoder 32 is configured to encode frames to be transmitted to the display device 37. The encoder 32 may be implemented using executable software or may be implemented on specific hardware such as an ASIC. Each frame includes all or part of an image generated by the image generator 31.

Additionally, each frame includes a predicted display window location. The predicted display window location is a location of a part of the generated image 2a, 2b, 2c which is likely to be displayed by the display device 37. The predicted display window location may be based on a viewing direction of the user obtained from the display device 37. The predicted display window location may be defined using one or more coordinates. For example, referring to FIG. 1, the predicted display window location may be defined using the coordinates of a corner or center of a predicted display window, and may be defined using a size of the predicted display window. The predicted display window location may be encoded as part of metadata included with the frame.

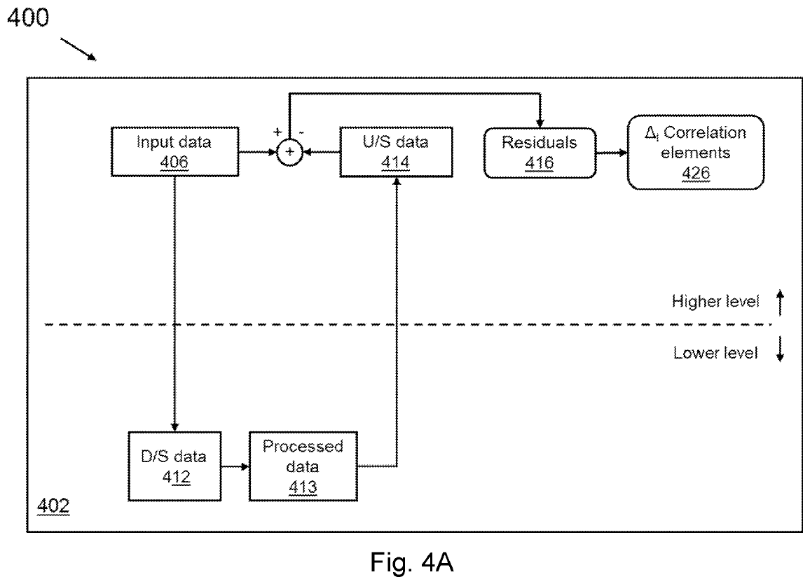

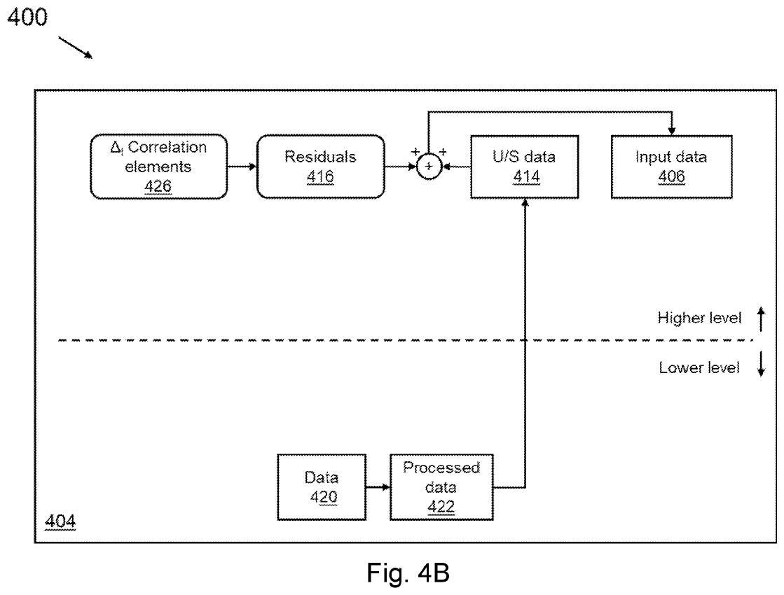

The encoder may apply inter-frame or intra-frame compression based on a currently-encoded frame and optionally one or more previously encoded frames. For example, the encoder 32 may be an LCEVC encoder as shown in FIG. 4A. The described methods are expected to improve compression with all codecs, but particularly with LCEVC.

The transmitter 33 may be any known type of transmitter for wired or wireless communications, including an Ethernet transmitter or a Bluetooth transmitter.

The network 34 is used for communication between the transmitter 33 and the receiver 35, and may be any known type of network such as a WAN or LAN or a wireless Wi-Fi or Bluetooth network. The network 34 may further be a composite of several networks of different types.

The receiver 35 may be any known type of receiver for wired or wireless communications, including an Ethernet transmitter or a Bluetooth transmitter.

The decoder 36 is configured to receive an encoded frame, and decode the encoded frame to obtain the generated image 3 and the predicted display window location. The decoder is further configured to adjust the generated image 3 to obtain a first adjusted image 2a, 2b, 2c corresponding to the predicted display window location. The decoder 36 may be implemented using executable software or may be implemented on specific hardware such as an ASIC.

The display device 37 may for example be a television screen or a VR headset. The display device 37 is configured to receive the first adjusted image 2a, 2b, 2c and to display a corresponding image 1a, 1b, 1c to the user. The timing of the display may be linked to a configured frame rate, such that the display device 37 may wait before displaying the image. The display device 37 may be configured to perform warping, that is, to obtain a final display window location, adjust the first adjusted image 2a, 2b, 2c to obtain a second adjusted image 1a, 1b, 1c corresponding to the final display window location, and display the second adjusted image. Because the first adjusted image corresponds to the images 2a, 2b and 2c which are transmitted to some known display devices (see FIG. 2), this warping may be a pre-existing technique, and the invention can be implemented without modifying the display device 37.

The image generator 31, encoder 32 and transmitter 33 may be consolidated into a single device, or may be separated into two or more devices. Collectively, the image generator 31, encoder 32 and transmitter 33 may be referred to as an “image source” part of the system.

The receiver 35, decoder 36 and display device 37 may be consolidated into a single device, or may be separated into two or more devices. For example, some VR headset systems comprise a base unit and a headset unit which communicate with each other. The receiver 35 and decoder 36 may be incorporated into such a base unit.

In some embodiments, the network 34 may be omitted. For example, a home display system may comprise a base unit configured as an image source, and a portable display unit comprising the display device 37.

In preferred examples, the encoders or decoders are part of a tier-based hierarchical coding scheme or format. Examples of a tier-based hierarchical coding scheme include LCEVC: MPEG-5 Part 2 LCEVC (“Low Complexity Enhancement Video Coding”) and VC-6: SMPTE VC-6 ST-2117, the former being described in PCT/GB2020/050695, published as WO 2020/188273, (and the associated standard document) and the latter being described in PCT/GB2018/053552, published as WO 2019/111010, (and the associated standard document), all of which are incorporated by reference herein. However, the concepts illustrated herein need not be limited to these specific hierarchical coding schemes.

A further example is described in WO2018/046940, which is incorporated by reference herein. In this example, a set of residuals are encoded relative to the residuals stored in a temporal buffer.

LCEVC (Low-Complexity Enhancement Video Coding) is a standardised coding method set out in standard specification documents including the Text of ISO/IEC 23094-2 Ed 1 Low Complexity Enhancement Video Coding published in November 2021, which is incorporated by reference herein.

FIGS. 4A and 4B schematically illustrate selected features of an LCEVC encoder 402 and LCEVC decoder 404 which illustrate how LCEVC can be used to efficiently encode and decode the static image area 3. Further implementation details for these types of encoders and decoders are set out in earlier-published patent applications GB1615265.4 and WO2020188273, each of which is incorporated here by reference.

In each of the encoder 402 and the decoder 404, items are shown on two logical levels. The two levels are separated by a dashed line. Items on the first, highest level relate to data at a relatively high level of quality. Items on the second, lowest level relate to data at a relatively low level of quality. The relatively high and relatively low levels of quality relate to a tiered hierarchy having multiple levels of quality. In some examples, the tiered hierarchy comprises more than two levels of quality. In such examples, the encoder 402 and the decoder 404 may include more than two different levels. There may be one or more other levels above and/or below those depicted in FIGS. 4A and 4B.

Referring to FIG. 4A, an encoder 402 obtains input data 406 at a relatively high level of quality. The input data 406 comprises a first rendition of a first time sample, t₁, of a signal at the relatively high level of quality. The input data 406 may, for example, comprise an image generated by the image generator 31. The encoder 402 uses the input data 406 to derive downsampled data 412 at the relatively low level of quality, for example by performing a downsampling operation on the input data 406. Where the downsampled data 412 is processed at the relatively low level of quality, such processing generates processed data 413 at the relatively low level of quality.

In some examples, generating the processed data 413 involves encoding the downsampled data 412. Encoding the downsampled data 412 produces an encoded signal at the relatively low level of quality. The encoder 402 may output the encoded signal, for example for transmission to the decoder 404. Instead of being produced in the encoder 402, the encoded signal may be produced by an encoding device that is separate from the encoder 402. The encoded signal may be an H.264 encoded signal. H.264 encoding can involve arranging a sequence of images into a Group of Pictures (GOP). Each image in the GOP is representative of a different time sample of the signal. A given image in the GOP may be encoded using one or more reference images associated with earlier and/or later time samples from the same GOP, in a process known as ‘inter-frame prediction’.

Generating the processed data 413 at the relatively low level of quality may further involve decoding the encoded signal at the relatively low level of quality. The decoding operation may be performed to emulate a decoding operation at the decoder 404, as will become apparent below. Decoding the encoded signal produces a decoded signal at the relatively low level of quality. In some examples, the encoder 402 decodes the encoded signal at the relatively low level of quality to produce the decoded signal at the relatively low level of quality. In other examples, the encoder 402 receives the decoded signal at the relatively low level of quality, for example from an encoding and/or decoding device that is separate from the encoder 402. The encoded signal may be decoded using an H.264 decoder. H.264 decoding results in a sequence of images (that is, a sequence of time samples of the signal) at the relatively low level of quality. None of the individual images is indicative of a temporal correlation between different images in the sequence following the completion of the H.264 decoding process. Therefore, any exploitation of temporal correlation between sequential images that is employed by H.264 encoding is removed during H.264 decoding, as sequential images are decoupled from one another. The processing that follows is therefore performed on an image-by-image basis where the encoder 402 processes video signal data.

In an example, generating the processed data 413 at the relatively low level of quality further involves obtaining correction data based on a comparison between the downsampled data 412 and the decoded signal obtained by the encoder 402, for example based on the difference between the downsampled data 412 and the decoded signal. The correction data can be used to correct for errors introduced in encoding and decoding the downsampled data 412. In some examples, the encoder 402 outputs the correction data, for example for transmission to the decoder 404, as well as the encoded signal. This allows the recipient to correct for the errors introduced in encoding and decoding the downsampled data 412.

In some examples, generating the processed data 413 at the relatively low level of quality further involves correcting the decoded signal using the correction data. In other examples, rather than correcting the decoded signal using the correction data, the encoder 402 uses the downsampled data 412.

In some examples, generating the processed data 413 involves performing one or more operations other than the encoding, decoding, obtaining and correcting acts described above.

However, in some examples no processing is performed on the downsampled data 412.

Data at the relatively low level of quality is used to derive upsampled data 414 at the relatively high level of quality, for example by performing an upsampling operation on the data at the relatively low level of quality. The upsampled data 414 comprises a second rendition of the first time sample of the signal at the relatively high level of quality. The encoder 402 obtains a set of residual elements 416 useable to reconstruct the input data 406 using the upsampled data 414. The set of residual elements 416 is associated with the first time sample, t₁, of the signal. The set of residual elements 416 is obtained by comparing the input data 406 with the upsampled data 414.

In this example, the encoder 402 generates a set of temporal correlation elements 426. The term “temporal correlation element” is used herein to mean a correlation element that indicates an extent of temporal correlation. The temporal correlation element may further be a spatio-temporal correlation element indicating an extent of spatial correlation between residual elements. In this example, the set of temporal correlation elements 426 is associated with both the first time sample, t₁, of the signal, and a second time sample, t₀, of the signal. In the examples described herein, the second time sample, t₀, is an earlier time sample relative to the first time sample. In other examples, however, the second time sample, t₀, is a later time sample relative to the first time sample, t₁. In some examples, where the input data 406 comprises a sequence of time samples, an earlier time sample means a time sample that precedes the first time sample, t₁, in the input data.

Where the first time sample, t₁, and the earlier time sample are arranged in presentation order, the earlier time sample precedes the first time sample, t₁.

The second time sample, t₀, may be an immediately preceding time sample in relation to the first time sample, t₁. In some examples, the second time sample, t₀, is a preceding time sample relative to the first time sample, t₁, but not an immediately preceding time sample relative to the first time sample, t₁.

In this example, the set of temporal correlation elements 426 is indicative of an extent of spatial correlation between a plurality of residual elements in the set of residual elements 416. The set of temporal correlation elements 426 is also indicative of an extent of temporal correlation between first reference data based on the input data 406 and second reference data based on a rendition of the second time sample, t₀, of the signal, for example at the relatively high level of quality. The first reference data is therefore associated with the first time sample, t₁, of the signal, and the second reference data is associated with the second time sample, t₀, of the signal. The first reference data and the second reference data are used as references or comparators for determining an extent of temporal correlation in relation to the first time sample, t₁, of the signal and the second time sample, t₂, of the signal. The first reference data and/or the second reference data may be at the relatively high level of quality.

In some examples, the first reference data and the second reference data comprise first and second sets of spatial correlation elements, respectively, the first set of spatial correlation elements being associated with the first time sample, t₁, of the signal, and the second set of spatial correlation elements being associated with the second time sample, t₀, of the signal.

In other examples, the first reference data and the second reference data comprise first and second renditions of the signal, respectively, the first rendition being associated with the first time sample, t₁, of the signal, and the second rendition being associated with the second time sample, t₀, of the signal.

The set of temporal correlation elements 426 will be referred to hereinafter as “Δt correlation elements”, since temporal correlation is exploited using data from a different time sample to generate the Δt correlation elements 426.

In this example, the encoder 402 transmits the set of Δt correlation elements 426 instead. Since the set of Δt correlation elements 426 exploit temporal redundancy at the higher, residual level, the set of Δt correlation elements 426 are likely to be small where there is a strong temporal correlation, and may comprise more correlation elements with zero values in some cases. Less data may therefore be used to transmit the set of Δt correlation elements 426 when applied to the static image area 3 (which is static, and only changes internally) when compared to the warpable images 2a, 2b, 2c (the boundaries of which can change for each frame).

Turning now to FIG. 4B, the decoder 404 receives data 420 based on the downsampled data 412 and receives the set of Δt correlation elements 426.

Where the encoder 402 has processed the downsampled data 412 to generate processed data 413, the decoder 404 processes the received data 420 to generate processed data 422. The processing may comprise decoding an encoded signal to produce a decoded signal at the relatively low level of quality. In some examples, the decoder 404 does not perform such processing on the received data 420. Data at the relatively low level of quality, for example the received data 420 or the processed data 422, is used to derive the upsampled data 414. The upsampled data 414 may be derived by performing an upsampling operation on the data at the relatively low level of quality.

The decoder 404 obtains the set of residual elements 416 based at least in part on the set of Δt correlation elements 426. The set of residual elements 416 is useable to reconstruct the input data 406 using the upsampled data 414.

This disclosure describes an implementation for integration of a hybrid backward-compatible coding technology with existing decoders, optionally via a software update. In a non-limiting example, the disclosure relates to an implementation and integration of MPEG-5 Part 2 Low Complexity Enhancement Video Coding (LCEVC). LCEVC is a hybrid backward-compatible coding technology which is a flexible, adaptable, highly efficient and computationally inexpensive coding format combining a different video coding format, a base codec (i.e. an encoder-decoder pair such as AVC/H.264, HEVC/H.265, or any other present or future codec, as well as non-standard algorithms such as VP9, AV1 and others) with one or more enhancement levels of coded data.

Example hybrid backward-compatible coding technologies use a down-sampled source signal encoded using a base codec to form a base stream. An enhancement stream is formed using an encoded set of residuals which correct or enhance the base stream for example by increasing resolution or by increasing frame rate. There may be multiple levels of enhancement data in a hierarchical structure. In certain arrangements, the base stream may be decoded by a hardware decoder while the enhancement stream may be suitable for being processed using a software implementation. Thus, streams are considered to be a base stream and one or more enhancement streams, where there are typically two enhancement streams possible but often one enhancement stream used. It is worth noting that typically the base stream may be decodable by a hardware decoder while the enhancement stream(s) may be suitable for software processing implementation with suitable power consumption. Streams can also be considered as layers.

The combined intermediate picture is then upsampled again to give a preliminary output picture at a highest resolution. A second enhancement sub-layer is combined with the preliminary output picture to give a combined output picture.

The second enhancement sub-layer may be partly derived from a temporal buffer, which is a store of the second enhancement sub-layer used for a previous frame. An indication of whether the temporal buffer can be used for the current frame, or which parts of the temporal buffer can be used for the current frame, may be included with the encoded frame. The use of a temporal buffer reduces the amount of data needs to be included as part of the encoded frame. A temporal buffer may equally be used for the first enhancement sub-layer.

The video frame is encoded hierarchically as opposed to using block-based approaches as done in the MPEG family of algorithms. Hierarchically encoding a frame includes generating residuals for the full frame, and then a reduced or decimated frame and so on. In the examples described herein, residuals may be considered to be errors or differences at a particular level of quality or resolution.

For context purposes only, as the detailed structure of LCEVC is known and set out in the approved draft standards specification, FIG. 1 illustrates, in a logical flow, how LCEVC operates on the decoding side assuming H.264 as the base codec. Those skilled in the art will understand how the examples described herein are also applicable to other multi-layer coding schemes (e.g., those that use a base layer and an enhancement layer) based on the general description of LCEVC The LCEVC decoder works at individual video frame level. It takes as an input a decoded low-resolution picture from a base (H.264 or other) video decoder and the LCEVC enhancement data to produce a decoded full-resolution picture ready for rendering on the display view. The LCEVC enhancement data is typically received either in Supplemental Enhancement Information (SEI) of the H.264 Network Abstraction Layer (NAL), or in an additional data Packet Identifier (PID) and is separated from the base encoded video by a demultiplexer. Hence, the base video decoder receives a demultiplexed encoded base stream and the LCEVC decoder receives a demultiplexed encoded enhancement stream, which is decoded by the LCEVC decoder to generate a set of residuals for combination with the decoded low-resolution picture from the base video decoder.

LCEVC can be rapidly implemented in existing decoders with a software update and is inherently backwards-compatible since devices that have not yet been updated to decode LCEVC are able to play the video using the underlying base codec, which further simplifies deployment.

In this context, there is proposed herein a decoder implementation to integrate decoding and rendering with existing systems and devices that perform base decoding. The integration is easy to deploy. It also enables the support of a broad range of encoding and player vendors, and can be updated easily to support future systems. Embodiments of the invention specifically relate to how to implement LCEVC in such a way as to provide for decoding of protected content in a secure manner.

The proposed decoder implementation may be provided through an optimised software library for decoding MPEG-5 LCEVC enhanced streams, providing a simple yet powerful control interface or API. This allows developers flexibility and the ability to deploy LCEVC at any level of a software stack, e.g. from low-level command-line tools to integrations with commonly used open-source encoders and players. In particular, embodiments of the present invention generally relate to a driver-level implementations and a System on a chip (SoC) level implementation.

The terms LCEVC and enhancement may be used herein interchangeably, for example, the enhancement layer may comprise one or more enhancement streams, that is, the residuals data of the LCEVC enhancement data.

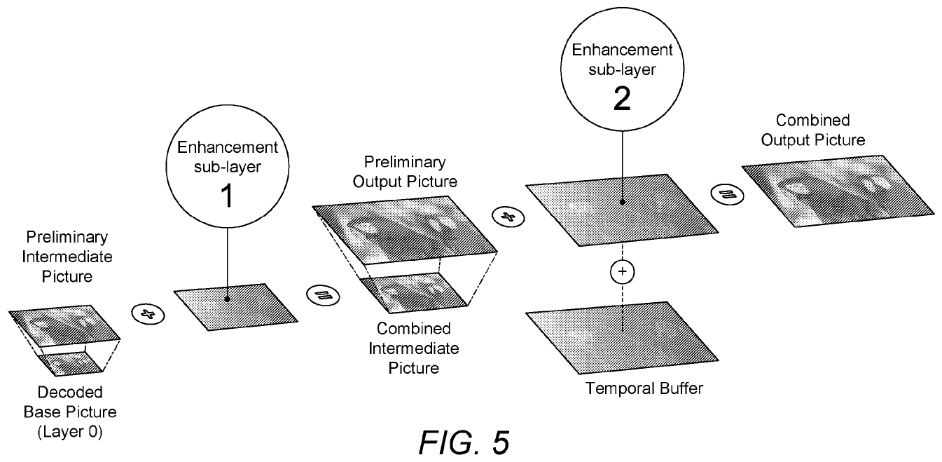

FIG. 5 is a schematic diagram showing process flow of LCEVC. At a first step, a base decoder decodes a base layer to obtain low resolution frames (i.e. the base layer). As a next step, an initial enhancement (a sub layer of the enhancement layer) corrects artifacts in the base. As a further step, final frames (for output) are reconstructed at the target resolution by a applying further (e.g. further residual details) sub layer of the enhancement layer. This illustrates that by best exploiting the characteristics of existing codecs and the enhancement, LCEVC improves quality and reduces the overall computational requirements of encoding. Embodiments of the invention provide for this to be achieved in a secure manner (e.g. when handling protected content).

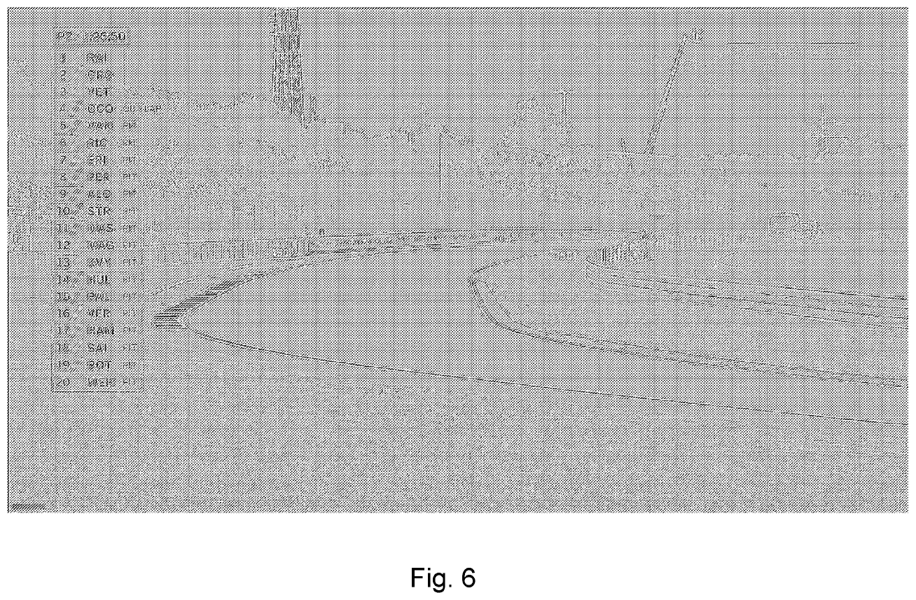

FIG. 6 illustrates an enhancement layer. As can be seen, the enhancement layer comprises sparse highly detailed information, which are not interesting (or valuable to a viewer) without the base video.

In the context of the presently addressed problem, subtle movements in the rendered XR view would increase the information stored in this enhancement layer.

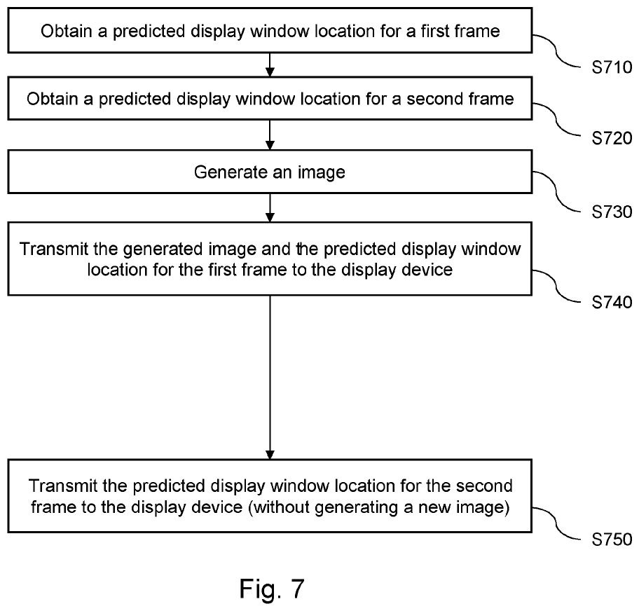

FIG. 7 is a flow chart schematically illustrating an example method performed by the image generator 31.

Referring to FIG. 7, at step S710, the image generator 31 obtains a predicted display window location for a first frame.

The predicted display window location is a portion of a 2D or 3D area. The predicted display window location may be denoted by coordinates, for example denoting a viewing position (i.e. where the user is “located” in the 2D or 3D area), viewing orientation (i.e. the direction the user is looking in the 2D or 3D area) and/or viewing range (in terms of angle and/or distance) within a 3D space. The “predicted display window location” may alternatively be termed a “predicted field of view”. The predicted display window location may, for example, be predicted based on a state or event in a virtual environment (such as a dynamically-generated game or a 3D video recording).

Additionally, the predicted display window location may be predicted based on feedback from a display device 37. For example, where the display device 37 is a VR headset, the predicted display window location may move with real motion of the display device 37. For example, the feedback may comprise a position vector and/or motion vector of the display device 37.

The first frame may be a next frame to be displayed by the display device 31. In other words, the predicted display window location for the first frame is a predicted display window location at a short time in the future, where the short time corresponds to a minimum delay between rendering and display (e.g. 30 ms).

At step S720, the image generator 31 obtains a predicted display window location for a second frame.

The second frame may immediately follow the first frame, or may follow two or more frames after the first frame. In other words, the predicted display window location for the second frame may be a predicted display window location at a time that is an integer multiple of the frame spacing after the first frame is displayed.

At step S730, the image generator 31 generates an image 3. The image 3 represents an oversized portion of the 2D or 3D area, including at least the predicted display window location for the first frame and the predicted display window location for the second frame. In other words, when it is predicted that a user's viewing orientation or viewing range will change between the first and second frame, the generated image includes enough information to display both frames. The generated image can then be cropped, translated or rotated at the display device 37 to generate the first and second frames. In some embodiments, the generated image may support changes in the viewing position (or even changes in the position of objects within a virtual environment), however this would require some further rendering (or at least coordinate transformation) at the display device 37 before the frames can be displayed. Therefore, a time between the first and second frames is preferably chosen such that any changes in the viewing position (and motion of objects within the virtual environment) is minimal or zero.

The image may be generated based on further information such as a resolution of the display device 37.

In an alternative, step S720 may be omitted, and the generated image may simply represent an oversized portion of the 2D or 3D area including the predicted display window location for the first frame. The degree to which the generated image is oversized may, for example, be a fixed predetermined oversizing, or may be based on a speed at which the viewing orientation or viewing range is changing.

In a further alternative, both of steps S710 and S720 may be omitted, and the generated image may represent a fixed portion of the 2D or 3D area, or the whole of the 2D or 3D area. For example, the image generator 31 may generate images of a complete virtual environment at a first frame rate and the display device 37 may display frames comprising portions of the virtual environment at a second frame rate higher than the first frame rate.

At step S740, the image generator 31 transmits the generated image and the predicted display window location for the first frame to the display device 37, so that the display device 37 can display the first frame.

Transmission of the generated image may involve compressing and/or encoding the image. For example, the image may be encoded using LCEVC or VC-6 coding.

At step S750, the image generator 31 transmits the predicted display window location for the second frame to the display device, so that the display device 37 can display the second frame using the previously-received generated image.

Alternatively, step S750 may be omitted. For example, if the display device 37 obtains feedback about user motion, the display device 37 may calculate the display window location for the second frame without requiring further data from the image generator 31.

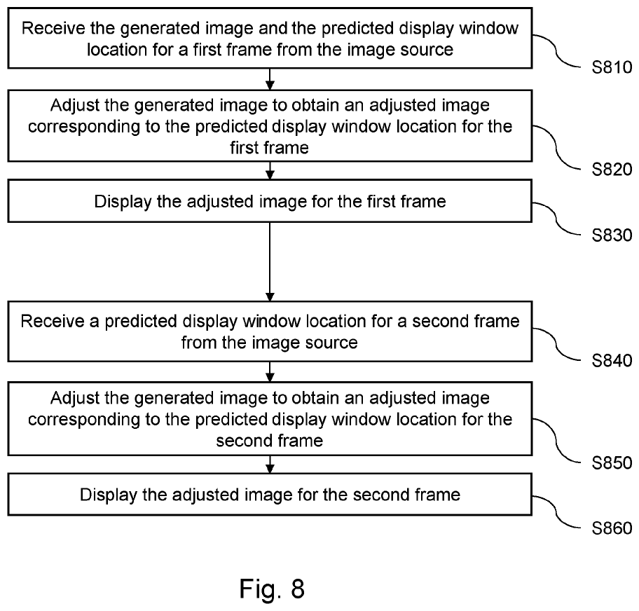

FIG. 8 is a flow chart schematically illustrating a method performed by a display device. This method corresponds to the method of FIG. 7 performed by the image generator. In particular, step S810 corresponds to step S740 and step S840 corresponds to step S750.

Referring to FIG. 8, at step S810, the display device 37 receives the generated image 3 and the predicted display window location for the first frame from the image source 31. The display device 37 may store the generated image in a memory.

At step S820, the display device 37 adjusts the generated image 3 to obtain an adjusted image 2a or 1a corresponding to the predicted display window location for the first frame. For example, the display device 37 may crop, translate or rotate the generated image, based on the predicted display window location, to obtain the adjusted image for the first frame.

At step S830, the display device 37 displays the adjusted image 2a or 1a for the first frame.

At step S840, the display device 37 receives the predicted display window location for the second frame from the image source 31. Alternatively, the display device 37 may calculate a display window location for the second frame (as discussed below) without receiving a predicted display window location for the second frame.

Steps S850 and S860 for the second frame are then similar to steps S820 and S830 for the first frame, although the generated image 3 received in step S810 is used again in order to display the adjusted image 2b or 1 b for the second frame, without requiring a further image to be received in step S840.

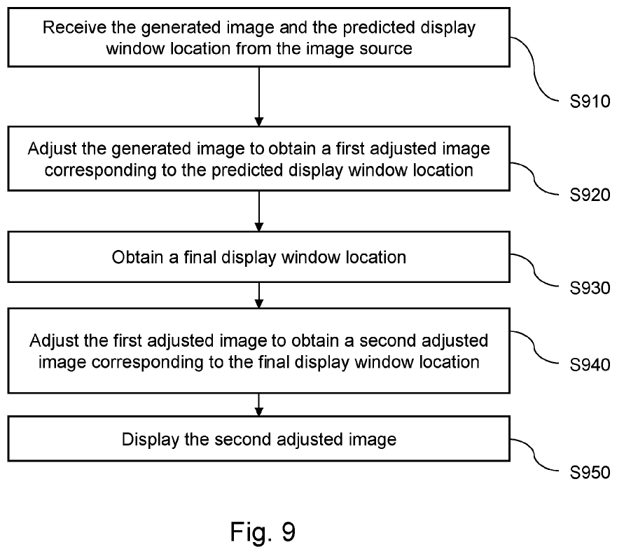

FIG. 9 is a flow chart schematically illustrating a further method performed by a display device. The method of FIG. 9 differs from FIG. 8 in that time warp is applied before displaying a frame. In other words, steps S910 and S920 correspond to either of steps S810 and S820 or steps S840 and S850.

Referring to FIG. 9, at step S930, the display device 37 obtains a final display window location for a frame. The final display window location differs from the predicted display window location as a result of any changes to the viewing position, viewing orientation and/or viewing range that occurred between rendering of the generated image at the image source 31 and display of the frame at the display device 37 and that were not anticipated in the predicted display window location.

At step S940, the display device 37 adjusts a first adjusted image 2a (obtained in step S920) to obtain a second adjusted image 1a corresponding the final display window location. This is a similar process to step S920, and may involve cropping, rotating or translating the first adjusted image.

At step S950, the display device 37 displays the second adjusted image 1a (instead of displaying the first adjusted image 2a).

As an alternative to the method of FIG. 9, the final display window location (step S930) may be obtained before adjusting the generated image, and steps S920 and S940 may be combined into a single adjusting step of adjusting the generated image to obtain the second adjusted image corresponding to the final display window location.

As a further alternative, transmitting of the predicted display window location may be entirely omitted. In other words, the image source 31 may perform a method as set out in FIG. 7 and described above, but without transmitting any predicted display locations. In that case, the display device 37 may: receive the generated image from the image source (similarly to step S910); obtain a final display window location (as in step S930); adjust the generated image to obtain a second adjusted image corresponding to the final display window location; and display the second adjusted image. This alternative is particularly relevant if the display window location is determined based on motion of a headset display device 37, in which case the image source 31 cannot usefully provide additional information to the display device 37 about the display window location.

According to an example, there is provided a method of generating an extended reality field of view for efficiently encoding subtle movements in a video sequence, comprising: identifying an initial field of view to be presented to a user; generating an enlarged field of view relative to the initial field of view; generating a set of coordinates in the enlarged field of view, the coordinates identifying a starting location for a display window; instructing an enhancement encoder to encode the enlarged field of view and the set of coordinates. The enhancement encoder comprises: one or more respective base encoders to implement a base encoding layer to encode a video signal, and an enhancement encoder to implement an enhancement decoding layer, the enhancement decoder being configured to: encode an enhancement signal to generate one or more layers of residual data, the one or more layers of residual data being generated based on a comparison of data derived from the decoded video signal and data derived from an original input video signal,

According to a further example there is provided a method of generating an extended reality user display from a received field of view, comprising: receiving an enlarged field of view decoded by an enhancement decoder; receiving a set of coordinates decoded by the enhancement encoder; creating a display window in the enlarged field of view using the set of coordinates; and presenting the display window to the user.

1. A system for displaying an image frame sequence, the system comprising an image source and a display device,
wherein the image source is configured to:
generate an image;
obtain a predicted display window location; and
transmit the generated image and the predicted display window location to the display device; and
wherein the display device is configured to:
receive the generated image and the predicted display window location from the image source; and
adjust the generated image to obtain a first adjusted image corresponding to the predicted display window location.

2. A system according to claim 1, wherein the display device is further configured to:
obtain a final display window location; and
adjust the first adjusted image to obtain a second adjusted image corresponding to the final display window location.

3. A system according to claim 2, wherein the display device is further configured to:
display the second adjusted image.

4. A system according to any of claims 2 to 3, wherein the final display window location is a field of view of a user in a 3D rendered space, at a time of displaying the image.

5. A system according to any of claims 2 to 4, wherein adjusting the first adjusted image comprises cropping, translating or rotating the first adjusted image.

6. A system according to any preceding claim, wherein the predicted display window location is a prediction of a field of view of a user in a 3D rendered space at a time of displaying the image frame, wherein the prediction is made at a time of rendering the image frame.

7. A system according to any preceding claim, wherein adjusting the generated image comprises cropping, translating or rotating the generated image.

8. A system according to any preceding claim, wherein the predicted display window location is indicated using a coordinate value.

9. A system according to any preceding claim, wherein the display device is configured to store the generated image of a previous frame and the image source is configured to transmit a difference between the generated image of a current frame and the generated image of the previous frame.

10. A system according to any preceding claim, wherein:
the image source comprises an encoder and the display device comprises a decoder,
the image source is configured to:
encode the generated image and the predicted display window location as an encoded frame; and
transmit the encoded frame to the display device, and
the display device is configured to:
receive and decode the encoded frame to obtain the generated image and the predicted display window location.

11. A system according to claim 10, wherein the image encoder is an LCEVC encoder and the image decoder is an LCEVC decoder.

12. A system according to any preceding claim, further comprising a network, wherein the image source is configured to stream the image frame sequence to the display device over the network.

13. A transmission method for a system for displaying an image frame sequence, wherein the method comprises:
obtaining a generated image from an image source;
obtaining a predicted display window location; and
transmitting the generated image and the predicted display window location to the display device.

14. An encoding method for a system for displaying an image frame sequence, wherein the method comprises:
obtaining a generated image from an image source;
obtaining a predicted display window location; and
encoding the generated image and the predicted display window location as an encoded frame.

15. A receiving method for a system for displaying an image frame sequence, wherein the method comprises:
receiving a generated image and the predicted display window location from an image source; and
adjusting the generated image to obtain a first adjusted image corresponding to the predicted display window location.

16. A decoding method for a system for displaying an image frame sequence, wherein the method comprises:
decoding an encoded frame to obtain a generated image and a predicted display window location; and
adjusting the generated image to obtain a first adjusted image corresponding to the predicted display window location; and
outputting the first adjusted image for use by a display device.

17. A device configured to perform the method of any of claims 13-16.

18. A method of generating data suitable for constructing a series of frames of image data by a VR display device, the method comprising:
determining an oversized field of view comprising:
a first field of view corresponding to an expected field of view at the VR display device at a time of a first frame of image data; and
a second field of view corresponding to an expected field of view at the VR display device at a time of a second, later frame of image data;
generating an oversized image comprising said determined oversized field of view.

19. A method of generating a sequence of frames for displaying on a VR display device, optionally wherein the method is performed by the VR display device, the method comprising:
obtaining an oversized image having an oversized field of view, wherein the oversized field of view comprises: a first field of view corresponding to a display time of a first frame; and a second field of view corresponding to a display time of a second, later frame;
obtaining first positional data for the first frame, wherein the positional data is combinable with the oversized image to generate the first frame;
combining the oversized image with the first positional data, to generate the first frame for displaying on the VR display device at a first display time;
obtaining positional data for the second frame, wherein the positional data is combinable with a rendition of the oversized image to generate the second frame;
combining the rendition of the oversized image with the second positional data, to generate the second frame for displaying on the VR display device at a second display time,

20. A method according to claim 19, wherein the method further comprises:
receiving an encoded rendition of the oversized image; and
decoding the encoded rendition of the oversized image.

21. A method according to claim 20, wherein the encoded rendition of the oversized image is a rendition of the oversized image encoded by a LCEVC encoding method and the method further comprises decoding the encoded rendition of the oversized image comprises decoding in accordance with an LCEVC decoding method.

22. A method of pre-processing data for encoding, the method comprising:
generating an image for encoding, wherein a rendition of the image is for use by a VR display device for creating a VR display for a viewer,
wherein the image comprises a field of view:
larger than and encompassing a field of view of the viewer at a generation time of the oversized image;
larger than and encompassing a field of view of the viewer at a display time of the generated image; and
larger than and encompassing a field of view of the viewer at a display time of a further image;
wherein the generated image and the further image form a sequence of images suitable for viewing by a viewer, the further image being displayed later in the sequence than the generated image.

23. The method of claim 22, further comprising:
encoding the image, in particular using an LCEVC encoding method;
sending the encoded image to a VR display device via a wired or wireless connection;
obtaining positional data, said positional data for obtaining a field of view of a user, wherein said positional data is indicative of the viewer's head/eye position and/or movement, wherein generating the image further comprises processing said positional data associated with a time of said generation of the image.

24. A method, preferably performed by a VR viewing device, the method comprising:
adjusting an oversized image by using a received or generated first positional data to select a field of view encompassed within the oversized image at a first time, the first time being a time at which the oversized image was obtained or a time at which the selected field of view will be displayed; and
at a later time, updating a rendition of the oversized image by using a second received or generated positional data to select a field of view encompassed within the oversized image, wherein the selected field of view corresponds to the field of view of a viewer at the time of updating or a predicted time of display of the updated image.

25. The method of claim 24, further comprising:
generating the rendition of the oversized image by enhancing the oversized image using enhancement data,
in particular wherein the enhancement data is derived from a LCEVC enhancement layer.
